(19) United States
(12) Patent Application Publication
(10) Pub. No.: US 2024/0369862 A1
(43) Pub. Date: Nov. 7, 2024

(54) METHOD FOR MANUFACTURING AND OPACIFYING DEVICE FOR WINDOWS

(71) Applicant: VISION SYSTEMS, Brignais (FR)

(72) Inventors: Georges FIGURA, Brignais (FR); Claire MONTET, Grigny (FR)

(21) Appl. No.: 18/689,315

(22) PCT Filed: Sep. 1, 2022
(86) PCT No.: PCT/FR2022/051643

§ 371 Date: Mar. 5, 2024

(30) Foreign Application Priority Data
Sep. 6, 2021 (FR) 21/09303
Sep. 20, 2021 (FR) 21/09874

(51) Int. Cl. G02F 1/01; E06B 9/24

(52) U.S. Cl. CPC G02F 1/0136; E06B 9/24; G02F 1/0102; E06B 2009/2464

(57) ABSTRACT

The present disclosure relates to a method for manufacturing an opacifying device for windows or walls that are at least partially transparent, the manufacturing method including the following steps: obtaining a polarizable part including a central layer, two conducting layers surrounding the central layer, and two insulating layers surrounding the conducting layers; removing a portion of the polarizable part; obtaining two covering layers made from an electrically insulating material; depositing a conducting entity on each covering layer; securing the covering layers to the polarizable part, each conducting track having a free portion outside of the electrical connection access and able to be electrically connected to an external conductor.

### CROSS REFERENCE TO RELATED APPLICATIONS

This application is a National Stage of PCT Application No. PCT/FR2022/051643 filed on Sep. 1, 2022, which claims priority to the following French Patent Application Nos. 21/09303 filed on Sep. 6, 2021 and 21/09874 filed on Sep. 20, 2021, the contents each of which are incorporated herein by reference thereto.

### TECHNICAL FIELD

The present disclosure concerns a method for manufacturing an opacifying device for windows or walls that are at least partially transparent.

### BACKGROUND

It is known to use an opacifying device extending along an extension plane and being surrounded by windows or walls that are at least partially transparent.

Such a device makes it possible to vary the degree of opacity. It comprises a central layer made of a polarizable material surrounded by two conductive layers. The conductive layers are in themselves surrounded by insulating layers.

Since it is necessary to access the two conductive layers to subject them to a voltage so as to vary the degree of opacity, a portion of the insulating layers must be removed and conductors must be fastened on the conductive layers. It may be copper plates.

The fastening of the conductors is an operation which may prove difficult to carry out because the fastening must be sufficient to ensure good electrical contact.

Furthermore, the presence of conductors may locally cause an extra thickness of the opacifying device. However, this opacifying device must be as flat as possible to facilitate mounting with windows or walls that are at least partially transparent.

The present disclosure aims to solve all or part of the drawbacks mentioned above.

### BRIEF SUMMARY

To this end, the present disclosure concerns a method for manufacturing an opacifying device for windows or walls that are at least partially transparent, the manufacturing method comprising the following steps:
providing a polarizable part including a central layer with a polarizable material able to be opaque or at least partially transparent according to a voltage being subjected thereto, two conductive layers surrounding the central layer able to apply a voltage on either side of the central layer, and, two insulating layers surrounding the conductive layers,
removing a portion of the polarizable part so as to create electrical connection access to each conductive layer,
providing two cover layers made of an electrically insulating material,
depositing a conductive entity on each cover layer, the deposit securing the conductive entity on each cover layer so as to create at least one conductive track on each cover layer,
securing the cover layers provided with conductive tracks to the polarizable part, the cover layers provided with conductive tracks surrounding the polarizable part, each conductive track being in electrical contact with the corresponding conductive layer at the corresponding electrical connection access and each conductive track having a free part outside of the electrical connection access able to be electrically connected to an external conductor.

By the terms polarizable and opacifying, it is understood variation of hue under electronic control. The central layer may be made of SPD, PDLC or electrochromic film.

The polarizable part comprised two insulating layers to protect the central layer and the conductive layers. However, it is necessary to have access to the conductive layers to apply a voltage to the central layer in order to vary the opacity of the polarizable part.

The fact of preparing two cover layers separately is advantageous because the realization of the deposit on an electrically insulating material is easy. The cover layers are therefore prepared separately and the electrical tracks disposed so as to coincide with the electrical connection accesses on either side of the polarizable part.

Once the cover layers have been disposed around the polarizable part, the securing is also easy since the assembly, that is to say the opacifying device, is in the form of a stack of layers.

Once carried out, the opacifying device is also easy to handle and to integrate into a glazing because it is substantially flat due to the fact that it does not have any extra thickness at the connection to the electrical connection accesses.

According to one aspect of the present disclosure, the deposit of the conductive entity is carried out by printing. The adhesion of the conductive track is facilitated by this type of deposit.

According to one aspect of the present disclosure, the printing of the conductive entity is carried out by screen printing. This technique is well suited to the cover layers.

According to one aspect of the present disclosure, the conductive entity is a metallic ink.

The conductive tracks thus created have a limited thickness compared to the thickness of the cover layers while ensuring good electrical conductivity. The conductive tracks also have a reduced surface area, which enables space savings.

This is to be compared with a copper plate which may be used as a terminal for connecting to a conductive layer.

Alternatively or additionally, the conductive entity may comprise a conductive polymer and/or a carbon-based conductive material.

According to one aspect of the present disclosure, the conductive entity comprises silver.

According to one example, the conductive entity may comprise metallic silver particles and/or a conductive polymer. Different recipes may be defined by adjusting the silver concentration.

According to one aspect of the present disclosure, the cover layers are made of polymer.

The cover layers are made of a material which becomes adhesive when subjected to a defined temperature and/or pressure. According to one aspect of the present disclosure, the cover layers are made of thermoplastic polymer (TPU), polyvinyl butyral (PVB), ionoplast and/or ethylene vinyl acetate (EVA).

According to one aspect of the present disclosure, the insulating layers are made of thermoplastic polymer and in particular of polyethylene terephthalate (PET).

According to one aspect of the present disclosure, the conductive layers are made of indium tin oxide (ITO).

According to one aspect of the present disclosure, the step of removing a portion of the polarizable part consists in removing, over a defined perimeter, a portion of insulating layer, a portion of adjoining conductive layer, and a portion of central layer.

Thus, only the conductive layer and the opposite insulating layer remain within the defined perimeter. This arrangement implies a connection of the conductive tracks to the opposite conductive layer.

The removal is carried in this way because the conductive layers and the insulating layers are intrinsically bonded and their separation is difficult. The removal as well carried out, by taking off a part of the central layer, makes it easier to clear an access to a conductive layer.

According to one aspect of the present disclosure, the securing of the cover layers provided with conductive tracks to the polarizable part is carried out by baking according to a baking temperature lower than a limit value so as to obtain a partial molecular entanglement of the material constituting the cover layers to allow a subsequent additional baking for securing to windows or walls that are at least partially transparent.

The opacifying device thus created is able to be handled independently: it constitutes a stable and robust assembly because the cover layers protect the conductive tracks and the conductive layers.

Furthermore, the securing of the cover layers by baking enables the conductive tracks to gain in conductivity and to create better contact with the conductive layers.

By heating the ink film, the particles coalesce and the contact surfaces between the particles increase, thus reducing the resistances induced by the separation of the particles.

According to one aspect of the present disclosure, the manufacturing method further comprises a step of subsequent additional baking for securing to windows or walls that are at least partially transparent. The obtained assembly is an opacifying glazing or an opacifying partition.

According to one aspect of the present disclosure, a plurality of the opacifying devices are disposed side by side and a subsequent additional baking between two windows is carried out so as to constitute a multizone glazing.

This arrangement makes it possible to define different zones that may have different opacity.

Alternatively, a single baking may be performed with the aim of securing the assembly comprising the opacifying device and the two windows or walls that are at least partially transparent.

Preferably, the manufacturing method comprises a step of connecting the free parts of the conductive tracks to corresponding external conductors, the external conductors being able to subject the conductive tracks to a voltage in order to modify the degree of opacity of the central layer.

The conductive tracks are adapted to be connected to external conductors such as wires, lugs or flexible connectors (flex).

The external conductors are bonded to the conductive tracks in the same way as the conductive layers are bonded to the conductive tracks.

Thus the heat and/or the pressure allows the connection of the external conductors. This connection step may be carried out at the same time or after the securing step E5. It is also possible to carry out this connection step after the step of subsequent additional baking.

According to one aspect of the present disclosure, the limit value of the baking temperature is 100° C.

The limit value of the temperature makes it possible to carry out a partial baking of the cover layers. Thus, a subsequent additional baking is possible with the aim of surrounding the opacifying device with windows or walls that are at least partially transparent in a material with equivalent properties.

According to one aspect of the present disclosure, the securing of the cover layers provided with conductive tracks to the polarizable part is carried out by baking under a vacuum comprised between 0 and −980 mbar or by using an autoclave or a heating press configured to apply a determined pressure.

Preferably, the vacuum is obtained by a vacuum bag. The press baking may be carried out flat or according to a guide configured to give an at least partially domed shape.

Preferably, the determined pressure is less than 5 bars and in particular less than 3 bars. According to one exemplary embodiment, a pressure of less than one bar is suitable.

According to one aspect of the present disclosure, a functional accessory of the opacifying device is inserted between an insulating layer and a cover layer before the securing step so as to be in electrical contact with at least one conductive track.

This arrangement makes it possible to use at least one conductive track to power a functional accessory intended to be integrated into the opacifying device.

According to one aspect of the present disclosure, the functional accessory is in the form of a card provided with a connection intended to cooperate with at least one conductive track.

Preferably, the functional accessory comprises an antenna, a heating resistor, a RFID chip, a sensor, for example of luminosity, a probe, for example of temperature and/or a LED.

According to one aspect of the present disclosure, the polarizable part has a central extension plane and a thickness orthogonal to the central extension plane, the cover layers provided with conductive tracks each having a portion with a part of the conductive track extending outside of an extension area of the polarizable part along the central extension plane.

In other words, the cover layers each have a portion with a conductive track extending further than the polarizable part so that the conductive tracks have a part in the open air.

Thus, the connection of the conductive tracks to a voltage source is facilitated since the tracks are easily accessible.

Furthermore, the polarizable part substantially corresponding to the area of the final glazing along the central extension plane, the portions with a part of conductive tracks of the cover layers are easy to mask in a frame of the glazing.

According to one aspect of the present disclosure, each cover layer comprises a plurality of conductive tracks. One conductive track is sufficient but for the sake of safety of maintaining the electrical contact, a redundancy is put in place. Preferably, the plurality of conductive tracks of a cover layer come together to form a plate of conductive entity in the extension area of the polarizable part.

The plate of conductive entity is intended to be in contact with the corresponding conductive layer after the securing step. Preferably, the plate of conductive entity has holes so as to improve the adhesion of the cover layer to the conductive layer at the holes.

The arrangement of the conductive entity in the form of tracks joining to form a perforated plate makes it possible to improve the electrical contact.

According to one aspect of the present disclosure, each conductive track ends with a connection terminal on the cover layer outside of the extension area of the polarizable part.

Thus, each conductive track has a free part able to be electrically connected to an external conductor.

The present disclosure also concerns an opacifying device for windows or walls that are at least partially transparent comprising:
a polarizable part including a central layer with a polarizable material able to be opaque or at least partially transparent according to a voltage being subjected thereto, two conductive layers surrounding the central layer able to apply a voltage on either side of the central layer, and, two insulating layers surrounding the conductive layers,
a removal of a portion of the polarizable part so as to create an electrical connection access to each conductive layer,
two cover layers made of an electrically insulating material, each cover layer being provided with a conductive entity in the form of a conductive track,
at least one conductive track disposed on each cover layer, the cover layers surrounding the polarizable part, each conductive track being in electrical contact with the corresponding conductive layer at an electrical connection access provided in the corresponding insulating layer and each conductive track having a free part able to be electrically connected to an external conductor.

According to one aspect of the present disclosure, the conductive entity is a metallic ink.

Alternatively or additionally, the conductive entity may comprise a conductive polymer and/or a carbon-based conductive material.

According to one aspect of the present disclosure, the conductive entity comprises silver.

According to one example, the conductive entity may comprise metallic silver particles and/or a conductive polymer. Different recipes may be defined by adjusting the silver concentration.

According to one aspect of the present disclosure, the cover layers are made of polymer.

The cover layers are made of a material which becomes adhesive when subjected to a defined temperature and/or pressure. According to one aspect of the present disclosure, the cover layers are made of thermoplastic polymer (TPU), polyvinyl butyral (PVB), ionoplast and/or ethylene vinyl acetate (EVA).

According to one aspect of the present disclosure, the insulating layers are made of thermoplastic polymer and in particular of polyethylene terephthalate (PET).

According to one aspect of the present disclosure, the conductive layers are made of indium tin oxide (ITO).

According to one aspect of the present disclosure, the polarizable part has a central extension plane and a thickness orthogonal to the central extension plane, the cover layers provided with conductive tracks each having a portion with a part of conductive track extending outside of an extension area of the polarizable part according to the central extension plane.

In other words, the cover layers each have a portion with a conductive track extending further than the polarizable part so that the conductive tracks have a part able to be connected to an external conductor.

According to one aspect of the present disclosure, each cover layer comprises a plurality of conductive tracks. One conductive track is sufficient but for the sake of safety of maintaining the electrical contact, a redundancy is put in place. Preferably, the plurality of conductive tracks of a cover layer come together to form a plate of conductive entity in the extension area of the polarizable part.

The plate of conductive entity is intended to be in contact with the corresponding conductive layer after the securing step. Preferably, the plate of conductive entity has holes so as to improve the adhesion of the cover layer to the conductive layer at the holes.

The arrangement of the conductive entity in the form of tracks joining to form a perforated plate makes it possible to improve the electrical contact.

According to one aspect of the present disclosure, each conductive track ends with a connection terminal on the cover layer outside of the extension area of the polarizable part.

Thus, each conductive track has a free part able to be electrically connected to an external conductor.

The present disclosure also concerns an opacifying glazing or an opacifying partition, comprising the opacifying device described above and two windows or respectively two walls that are at least partially transparent.

The various non-incompatible aspects defined above may be combined.

### BRIEF DESCRIPTION OF THE DRAWINGS

The present disclosure will be better understood with the aid of the detailed description which is set out below with reference to the appended drawing in which:

FIG. 1 is a cross-sectional schematic view of a polarizable part of an opacifying device;

FIG. 2 is a cross-sectional schematic view of two cover layers on which conductive tracks are printed;

FIG. 3 is a cross-sectional schematic view of the opacifying device comprising the polarizable part and the two cover layers;

FIG. 4 is a cross-sectional schematic view of a glazing comprising the opacifying device and two windows;

FIG. 5 is a top perspective view of the opacifying device;

FIG. 6 is a diagram of the steps for manufacturing the opacifying device.

### DETAILED DESCRIPTION

In the detailed description which follows of the figures defined above, the same elements or the elements fulfilling identical functions may retain the same references so as to simplify the understanding of the present disclosure.

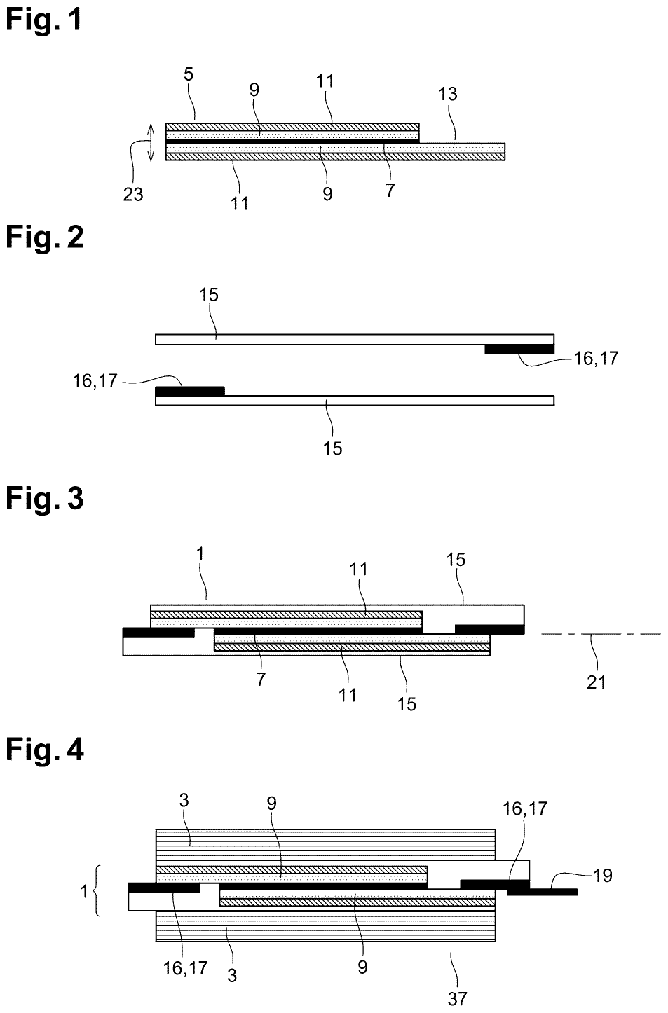

As illustrated in FIGS. 1 to 3 and 6, a method for manufacturing an opacifying device 1 for windows 3 or walls that are at least partially transparent comprises the steps described below.

A step E1 consists in providing a polarizable part 5 including a central layer 7 with a polarizable material able to be opaque or at least partially transparent according to a voltage being subjected thereto, two conductive layers 9 surrounding the central layer 7 able to apply a voltage on either side of the central layer 7, and, two insulating layers 11 surrounding the conductive layers 9.

By the terms polarizable and opacifying, it is understood variation of hue under electronic control. The central layer 7 may be made of SPD, PDLC or electrochromic film.

Here, the insulating layers 11 are made of thermoplastic polymer and in particular of polyethylene terephthalate (PET) and the conductive layers 9 are made of indium tin oxide (ITO).

A step E2 consists in removing a portion of each polarizable part 5 so as to create an electrical connection access 13 to each conductive layer 9. In FIG. 1, this removal has been represented in the insulating layer 11 from above.

It is a question of removing on a defined perimeter a portion of insulating layer 11, a portion of adjoining conductive layer 9, and a portion of central layer 7. Thus, there remains within the defined perimeter only the conductive layer 9 and the opposite insulating layer.

As illustrated in FIG. 2, a step E3 consists in providing two cover layers 15 made of an electrically insulating material.

The cover layers 15 are made of a material which becomes adhesive when subjected to a defined temperature and/or pressure. The cover layers 15 are made of polymer. The cover layers 15 may be made of thermoplastic polymer (TPU), polyvinyl butyral (PVB), ionoplast and/or ethylene vinyl acetate (EVA).

A step E4 then consists in depositing a conductive entity 16 on each cover layer, the deposit securing the conductive entity 16 on each cover layer so as to create at least one conductive track 17 on each cover layer 15. The deposit of the conductive entity 16 is carried out by printing. One possibility is to use the screen printing technique.

The conductive entity 16 is a metallic ink. The conductive tracks 17 thus created have a limited thickness compared to the thickness of the cover layers 15 while ensuring good electrical conductivity. The conductive tracks 17 also have a reduced surface area, which enable space savings.

This is to be compared with a copper plate which may be used as a terminal for connecting to a conductive layer 9. Alternatively or additionally, the conductive entity 16 may comprise a conductive polymer and/or a carbon-based conductive material.

The conductive entity 16 comprises silver. The conductive entity 16 may comprise metallic silver particles and/or a conductive polymer. Different recipes may be defined by adjusting the silver concentration.

As illustrated in FIG. 3, a step E5 consists in securing the cover layers 15 provided with conductive tracks 17 to the polarizable part 5.

The cover layers 15 provided with conductive tracks 17 surround the polarizable part 5, each conductive track 17 being in electrical contact with the corresponding conductive layer 9 at the corresponding electrical connection access 13 and each conductive track 17 having a free part outside of the electrical connection access 13 able to be electrically connected to an external conductor 19 as illustrated in FIG. 4.

The polarizable part 5 comprises two insulating layers 11 to protect the central layer 7 and the conductive layers 9. It is however necessary to have access to the conductive layers 9 to apply a voltage to the central layer 7 in order to vary the opacity of the polarizable part 5.

The securing of the cover layers 15 provided with conductive tracks 17 to the polarizable part 5 is carried out by baking according to a baking temperature lower than a limit value so as to obtain a partial molecular entanglement of the material constituting the cover layers 15 to allow a subsequent additional baking for securing to windows 3 or walls that are at least partially transparent.

The opacifying device 1 thus created is able to be handled independently: it constitutes a stable and robust assembly because the cover layers 15 protect the conductive tracks 17 and the conductive layers 9.

The limit value of the baking temperature is 100° C. The limit value of the temperature makes it possible to carry out a partial baking of the cover layers 15. Thus, a subsequent additional baking is possible with the aim of surrounding the opacifying device 1 of windows 3 or walls that are at least partially transparent in a material with equivalent properties.

The securing of the cover layers 15 provided with conductive tracks to the polarizable part 5 is carried out by baking under a vacuum comprised between 0 and −980 mbar or by using an autoclave or a heating press configured to apply a determined pressure. Preferably, the determined pressure is less than 5 bars and in particular less than 3 bars. According to one exemplary embodiment, a pressure of less than one bar is suitable.

The vacuum is obtained by a vacuum bag. The press baking may be carried out flat or according to a guide configured to give an at least partially domed shape.

Alternatively, a single baking may be performed with the aim of securing the assembly comprising the opacifying device 1 and the two windows 3 or walls that are at least partially transparent.

A functional accessory 18 of the opacifying device may be inserted between an insulating layer 11 and a cover layer 15 before the securing step E5 so as to be in electrical contact with at least one conductive track 17.

The functional accessory 18 is in the form of a card provided with a connection intended to cooperate with at least one conductive track.

Preferably, the functional accessory 18 comprises an antenna, a heating resistor, a RFID chip, a sensor, for example of luminosity, a probe, for example of temperature and/or a LED.

As illustrated in FIGS. 1 to 5, the polarizable part 5 has a central extension plane 21 and a thickness 23 orthogonal to the central extension plane 21, the cover layers 15 provided with conductive tracks 17 each having a portion 25 with a part 27 of conductive track 17 extending outside of an extension area 29 of the polarizable part 5 along the central extension plane 21.

In other words, the cover layers 15 each have a portion 25 with conductive track 17 extending further than the polarizable part 5 so that the conductive tracks 17 have a part T1 able to be connected to an external conductor 19.

Thus, the connection of the conductive tracks 17 to a voltage source is facilitated since the tracks are easily accessible.

Furthermore, the polarizable part 5 substantially corresponding to the area of the final glazing along the central extension plane 21, the portions 25 with a part 27 of conductive tracks 17 of the cover layers 15 are easy to mask in a frame of the glazing.

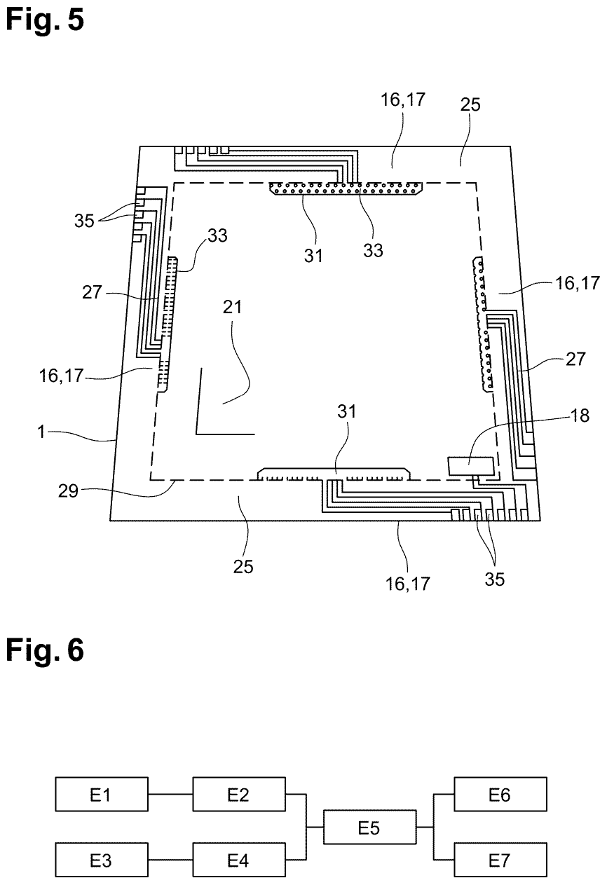

As illustrated in FIG. 5, each cover layer 15 may comprise a plurality of conductive tracks 17. One conductive track 17 is sufficient but for the sake of safety of maintaining the electrical contact, a redundancy is put in place. The plurality of conductive tracks 17 of a cover layer 15 come together so as to form a plate 31 of conductive entity 16 in the extension area 29 of the polarizable part 5.

The plate 31 of conductive entity 16 is intended to be in contact with the corresponding conductive layer 9 after the securing step. The plate 31 of conductive entity 16 has holes 33 so as to improve the adhesion of the cover layer 15 to the conductive layer 9 at the holes 33.

The arrangement of the conductive entity 16 in the form of the tracks joining to form a perforated plate 31 makes it possible to improve the electrical contact. There may also be several plates 31 of conductive entity 16 to improve the conductivity and thus improve the response of the polarizable material to changing the degree of opacity.

Each conductive track 17 ends with a connection terminal 35 on the cover layer 15 outside of the extension area 29 of the polarizable part. Thus, each conductive track 17 has a free part able to be electrically connected to an external conductor.

The manufacturing method further comprises a step E6 a subsequent additional baking for securing to windows 3 or walls that are at least partially transparent. The obtained assembly is an opacifying glazing or an opacifying partition.

According to one aspect of the present disclosure, a plurality of opacifying devices 1 are disposed side by side and a subsequent additional baking between two windows 3 is carried out so as to constitute a multizone glazing. This arrangement makes it possible to define different zones that may have different opacity.

The manufacturing method also comprises a step E7 of connecting the free parts of the conductive tracks 17 to corresponding external conductors 19, the external conductors 19 being able to subject the conductive tracks 17 to a voltage in order to modify the degree of opacity of the central layer 7.

The conductive tracks 17 are adapted to be connected to external conductors such as wires, lugs or flexible connector (flex).

The external conductors 19 are bonded to the conductive tracks 17 in the same way as the conductive layers 9 are bonded to the conductive tracks 17.

Thus the heat and/or the pressure allows the connection of the external conductors 19. This connection step E7 may be carried out at the same time or after the securing step E5. It is also possible to carry out this connection step E7 after the step E6 of subsequent additional baking.

As illustrated in FIG. 4, an opacifying glazing 37 or an opacifying partition is obtained, comprising the opacifying device 1 described above and two windows 3 or respectively two walls that are at least partially transparent.

It appears that the fact of preparing two cover layers 15 separately is advantageous because the realization of the deposit of conductive entity 16 on an electrically insulating material is easy. The cover layers 15 are therefore prepared separately and the electrical tracks disposed so as to coincide with the electrical connection accesses on either side of the polarizable part 5.

Once the cover layers have been disposed around the polarizable part 5, securing is also easy since the assembly, that is to say the opacifying device 1, is in the form of a stack of layers.

Once carried out, the opacifying device 1 is also easy to handle and to integrate into a glazing because it is substantially flat due to the fact that it does not have any extra thickness at the connection to the electrical connection accesses 13.

Furthermore, the securing of the cover layers 15 by baking allows the conductive tracks to gain in conductivity and to create better contact with the conductive layers 9.

It goes without saying that the present disclosure is not limited to the single embodiment described above by way of example, on the contrary it embraces all variants.

1. A method for manufacturing an opacifying device for windows or walls that are at least partially transparent, the manufacturing method comprising the following steps:
providing a polarizable part including a central layer with a polarizable material able to be opaque or at least partially transparent according to a voltage being subjected thereto, two conductive layers surrounding the central layer able to apply a voltage on either side of the central layer, and, two insulating layers surrounding the two conductive layers,
removing a portion of the polarizable part so as to create an electrical connection access to each conductive layer,
providing two cover layers made of an electrically insulating material,
depositing a conductive entity on each cover layer, the depositing securing the conductive entity to each cover layer so as to create at least one conductive track on each cover layer,
securing the cover layers provided with conductive tracks to the polarizable part, the cover layers provided with conductive tracks surrounding the polarizable part, each conductive track being in electrical contact with a corresponding conductive layer of the two conductive layers at the corresponding electrical connection access and each conductive track having a free part outside of the electrical connection access able to be electrically connected to an external conductor.

2. The method for manufacturing the opacifying device for windows or walls that are at least partially transparent according to claim 1, wherein the depositing of the conductive entity is carried out by printing.

3. The method for manufacturing the opacifying device for windows or walls that are at least partially transparent according to claim 2, wherein the printing of the conductive entity is carried out by screen printing.

4. The method for manufacturing the opacifying device for windows or walls that are at least partially transparent according to claim 1, wherein the conductive entity is a metallic ink.

5. The method for manufacturing the opacifying device for windows or walls that are at least partially transparent according to claim 4, wherein the conductive entity comprises silver.

6. The method for manufacturing the opacifying device for windows or walls that are at least partially transparent according to claim 1, wherein the step of removing a portion of the polarizable part consists in removing on a defined perimeter a portion of insulating layer, a portion of adjoining conductive layer, and a portion of central layer.

7. The method for manufacturing the opacifying device for windows or walls that are at least partially transparent according to claim 1, wherein the securing of the cover layers provided with conductive tracks to the polarizable part is carried out by baking according to a baking temperature lower than a limit value so as to obtain a partial molecular entanglement of the material constituting the cover layers to allow a subsequent additional baking for securing to windows or walls that are at least partially transparent.

8. The method for manufacturing the opacifying device for windows or walls that are at least partially transparent according to claim 7, wherein the securing of the cover layers provided with conductive tracks to the polarizable part is carried out by baking under a vacuum comprised between 0 and −980 mbar or by using an autoclave or a heating press configured to apply a determined pressure.

9. The method for manufacturing the opacifying device for windows or walls that are at least partially transparent according to claim 1, wherein a functional accessory of the opacifying device is inserted between an insulating layer and a cover layer before the securing step so as to be in electrical contact with at least one conductive track.

10. The method for manufacturing the opacifying device for windows or walls that are at least partially transparent according to claim 1, wherein the polarizable part has a central extension plane and a thickness orthogonal to the central extension plane, the cover layers provided with conductive tracks each having a portion with a part of conductive track extending outside of an extension area of the polarizable part along the central extension plane.

11. An opacifying device for windows or walls that are at least partially transparent comprising:
a polarizable part including a central layer with a polarizable material able to be opaque or at least partially transparent according to a voltage being subjected thereto, two conductive layers surrounding the central layer able to apply a voltage on either side of the central layer, and, two insulating layers surrounding the two conductive layers,
a removal of a portion of the polarizable part so as to create an electrical connection access to each conductive layer,
two cover layers made of an electrically insulating material, each cover layer being provided with a conductive entity in the form of a conductive track,
at least one conductive track disposed on each cover layer of the two cover layers, the two cover layers surrounding the polarizable part, the at least one conductive track being in electrical contact with a corresponding conductive layer of the two conductive layers at an electrical connection access provided in a corresponding insulating layer of the two insulating layers and the at least one conductive track having a free part able to be electrically connected to an external conductor.

12. The opacifying device for windows or walls that are at least partially transparent according to claim 11, wherein the conductive entity is a metallic ink.

13. The opacifying device for windows or walls that are at least partially transparent according to claim 12, wherein the conductive entity comprises silver.

14. The opacifying device for windows or walls that are at least partially transparent according to claim 11, wherein the cover layers are made of polymer.

15. The opacifying device for windows or walls that are at least partially transparent according to claim 11, wherein the polarizable part has a central extension plane and a thickness orthogonal to the central extension plane, the cover layers provided with conductive tracks each having a portion with a part of conductive track extending outside of an extension area of the polarizable part along the central extension plane.

16. The method for manufacturing the opacifying device for windows or walls that are at least partially transparent according to claim 3, wherein the conductive entity is a metallic ink.

17. The method for manufacturing the opacifying device for windows or walls that are at least partially transparent according to claim 16, wherein the conductive entity comprises silver.

18. The method for manufacturing the opacifying device for windows or walls that are at least partially transparent according to claim 17, wherein the step of removing a portion of the polarizable part consists in removing on a defined perimeter a portion of insulating layer, a portion of adjoining conductive layer, and a portion of central layer.

19. The method for manufacturing the opacifying device for windows or walls that are at least partially transparent according to claim 18, wherein the securing of the cover layers provided with conductive tracks to the polarizable part is carried out by baking according to a baking temperature lower than a limit value so as to obtain a partial molecular entanglement of the material constituting the cover layers to allow a subsequent additional baking for securing to windows or walls that are at least partially transparent.

20. The method for manufacturing the opacifying device for windows or walls that are at least partially transparent according to claim 19, wherein the securing of the cover layers provided with conductive tracks to the polarizable part is carried out by baking under a vacuum comprised between 0 and −980 mbar or by using an autoclave or a heating press configured to apply a determined pressure.
